(19) United States
(12) Patent Application Publication
(10) Pub. No.: US 2026/0311360 A1
(43) Pub. Date: Oct. 8, 2026

(54) Load Handling Device for an Industrial Truck

(71) Applicants: VETTER Industrie GmbH, Burbach (DE); AKL-tec GmbH, Alsdorf (DE)

(72) Inventors: Arnold VETTER, Wilnsdorf (DE); Tim BRENNER, Scheuerfeld (DE); Rüdiger ELBEN, Wilnsdorf (DE)

(73) Assignees: VETTER Industrie GmbH, Burbach (DE); AKL-tec GmbH, Alsdorf (DE)

(21) Appl. No.: 19/635,864

(22) Filed: Apr. 1, 2026

(30) Foreign Application Priority Data
Apr. 4, 2025 (DE) 10 2025 113 232.1
Mar. 17, 2026 (EP) 26 165 301.8

(51) Int. Cl. G06T 7/62; B66F 9/075; B66F 17/00; F16G 13/16; G01B 11/02; G01G 19/08

(52) U.S. Cl. CPC G06T 7/62; B66F 9/0755; B66F 17/003; F16G 13/16; G01B 11/02; G01G 19/083; G06T 2207/30248

(57) ABSTRACT

A load handling device has a base body in the form of a fork or a grapple of an industrial truck. At least one digital sensor is disposed on the base body for generating digital image data and the load handling device is coupled to an evaluation device for evaluating the digital image data. In order to more accurately determine the volume of a picked-up load even when the shaded side, facing away from the industrial truck, of the load has a non-homogeneous cubature. The digital sensor is extendable on the base body, in particular into the space in front of the load handling device. The sensor is oriented in a—in relation to a direction of extension R—rearward-facing viewing direction in order to generate the digital images for at least parts of the shaded side of the load.

### CROSS-REFERENCE TO RELATED APPLICATIONS

This application claims the benefit of German Patent Application DE 10 2025 113 232.1, filed on Apr. 4, 2025, und European Patent Application; EP 26 165 301.8, filed on Mar. 17, 2026, the entire contents of each of which are incorporated herein by reference.

### TECHNICAL FIELD

The present disclosure relates to a load handling device, also referred to as a load pick-up device, having a base body in the form of a fork or a grapple of an industrial truck for picking up a load. The present disclosure further relates to an associated industrial truck, for example, a forklift, and to a method for operating an industrial truck having such a load pick-up device.

### BACKGROUND

Industrial trucks having load handling devices, for example in the form of forks or grapples, and methods for operating same are well established in the prior art.

In logistics, i.e. for example in shipping or air freight consolidation, it is often necessary to determine as accurately as possible the dimensions or the volume of a load or freight that is picked up by the industrial truck. For this purpose, for example, international patent application WO 2022/197500 A1 discloses a system mounted on an industrial truck for determining the dimensions of the picked-up freight. Specifically, the system provides that one or more sensors, for example radar sensors, acoustic sensors or cameras or lidars, are mounted on the industrial truck, for example on the attachment thereof, in particular on the mast thereof, where they measure the load on the forks. To do this, the sensors transmit a radar signal or light signal, for example, and an evaluation device can use the signal components reflected from the load to deduce the dimensions, the shape or the volume of the load.

As long as the load has a regular, for example cuboidal, shape, such as a wooden or cardboard box, the known system and method offer up good results when the cubature is presumed to be regular; see FIG. 6. However, sometimes irregularly shaped objects need to be transported and measured as well; then, the volume values ascertained by the known systems and methods are no longer accurate enough, because in the course of their calculations said systems and methods regularly presume-as stated-that the load also has a regular cubature, i.e. shape or structure, on the shaded sides or surfaces of the load which are not in the field of view of the sensor mounted on the industrial truck; see FIG. 7. The ascertained volumes are in these cases typically not accurate enough for use in legal and commercial contexts.

### SUMMARY

The disclosure is based on the object of refining a known load handling device, a known industrial truck and a known method for operating the industrial truck such that it is possible to more accurately determine the volume of a picked-up load even when the load has an irregular, i.e. non-homogeneous, cubature on its shaded side facing away from the industrial truck.

This object is solved with the load handling device as disclosed and claimed. Accordingly, the handling device is characterised in that there is a movement apparatus for extending the sensor in a direction of extension into the surrounding area of the load handling device, in particular-looking from the industrial truck-into the space in front of the load handling device, and back; and in that the sensor is oriented in a-in relation to the direction of extension-rearward-facing viewing direction in order to generate the digital image data for at least parts of the shaded side of the load.

The term “industrial truck” means an operator-driven or self-driving transport vehicle, in particular a forklift.

The term “load handling device” means, for example, a fork or a grapple of an industrial truck.

The term “surrounding area” means the space outside of a picked-up load and the load handling device, in particular-looking from the industrial truck-the space in front of the picked-up load.

A distinction is made in the description between an “extendable sensor” of the load handling device with a viewing direction directed rearwards-counter to its direction of extension-towards a shaded side of the load or towards parts thereof, and a “further sensor”, which is disposed on the industrial truck, e.g. on the control stand thereof, on the attachment thereof or on the rear end of the fork or the grapple, with a viewing direction in the direction of travel of the industrial truck, in particular towards the front side of the load, when the latter is picked up by the load handling device.

The fields of view of the two sensors are at least partially mutually exclusive. Therefore, the further sensor in particular looks towards the front side of the load being picked up; generally, however, it cannot see the shaded side of the load facing the extendable sensor. That is to say: “shaded side of the load” means the side of the load that is not visible to the further sensor, in particular the rear side of said load.

Conversely, the extendable sensor looks towards the shaded side of the load or towards parts thereof; generally, however, it cannot see the front side of the load facing the further sensor. However, there may also be sides or lateral faces of the load that are detected by both sensors.

The term “image data” means the measured data generated by the extendable sensor or the further sensor.

The term “measurement data” means the data about the cubature of the load, i.e. the spatial form, shape or structure of individual sides of the load, which was generated by evaluating the image data.

The digital image data, obtained or generated by the extendable sensor, for the shaded side of the load can advantageously be used, for example, for a more accurate subsequent calculation of the volume of the load. To record the shaded side of the load, the load handling device continues to use the said movement apparatus, which enables the sensor to extend out from the load handling device into the space in front of the load handling device and/or to the side thereof. The extending makes it possible to generate digital image data of the shaded side of the load from a certain distance and hence also from different viewing angles, which improves any evaluation or measurement results relating to the load. A further advantage of extending the sensor is that, in this way, the rear side of loads that protrude beyond the free end, i.e. the tip, of the load handling device can also be seen; this is provided that the sensor is extended by a travel distance that is greater than the distance by which the load protrudes beyond the tip of the load handling device.

According to one exemplary embodiment, the sensor is installed on the load handling device in a protective housing. Not only does this serve as protection from environmental influences, such as dirt, but it can also function as an interface that can be attached to the movement apparatus, in particular to the push rod.

The movement apparatus consists substantially of two subsystems, namely, a sensor positioning means, in particular in the form of a push rod, and a drivetrain. Both subsystems are articulatedly coupled together via a connecting element.

The drivetrain consists substantially of a gear motor and a leadscrew connected downstream, whereby the rotary motion of the gear motor is converted into a translational actuation motion, in particular a translational motion of a spindle nut screwed onto the spindle. Using the connecting element, this translational actuation motion of the spindle nut is transmitted to the push rod of the sensor positioning means, which is accompanied by transmission of a force.

The entire drivetrain, i.e. the gear motor, an optionally present (friction) clutch and the leadscrew, preferably a ball screw, form a contiguous unit.

This drivetrain unit is held in place merely by a single pivot bearing and is connected to the base body of the load handling device via just this pivot bearing. This prevents the drivetrain from jamming, wearing prematurely or even being destroyed owing to the base body of the load handling device bending during operation. An intentionally provided degree of axial play on the axis of the pivot bearing advantageously also makes it possible to compensate for any misalignment of the leadscrew.

The pivot bearing is advantageously coupled to the drivetrain via an axial and radial bearing of the leadscrew. Thus only one side of the spindle of the leadscrew is mounted on the bearing; the other end of the spindle is free and this is where the spindle nut is screwed onto the spindle. The spindle nut is preferably a wear-resistant polymer spindle nut and is rotatably mounted. This also offers the advantage that any misalignment in the region of the spindle nut owing to any potential load-related bending of the load handling device can be compensated for.

Lastly, a friction clutch can be connected between the gear motor and the leadscrew, preferably between the gear motor and the combined axial/radial bearing. This friction clutch acts as a buffer to protect the entire drivetrain from the effects of undesirably high forces. Since the leadscrew is not self-locking due to its large pitch, it could get damaged, for example in a collision owing to a force acting externally on the push rod. The friction clutch ensures that, in this case, the gear motor is decoupled in a toque-dependent manner from the leadscrew, thereby advantageously preventing elements of the drivetrain from being overloaded or breaking.

According to a further advantageous exemplary embodiment, the push rod is taken up and guided by at least two push rod bearings fixed in or on the base body of the load handling device, preferably linear ball bearings. These at least two bearings are recessed into or fixed in place in the load handling device. The two bearings are disposed mutually offset in the longitudinal direction of the push rod, so that even in this area, the slightest deformation of the fork body owing to severe loading does not prevent the push rod from functioning, for example due to jamming.

According to a further exemplary embodiment, the push rod has an anti-twist lock, for example in the form of a guide strip or bent edge. The anti-twist lock has the effect, as the name says, that the push rod cannot twist, in particular during operation of the sensors, thereby preventing the measurement results of the latter from being falsified.

Alternatively, however, twisting of the push rod and thus also of the sensors mounted on its free end may actually be desirable in order to view the shaded side of the load from other perspectives as well, in particular at different angle of rotations of the extendable sensor. For this purpose, a rotation device can be provided for rotating the extendable sensor in particular about the longitudinal axis of the push rod. The thus generated image data for the shaded side of the load from different perspectives can help with more accurately ascertaining the cubature of the rear side of the load and therefore with more accurately calculating the volume of the load.

The sensor at the free end of the push rod generally requires electrical power for its operation; this is typically supplied via an electrical supply line; alternatively, however, the sensor can also be rechargeable-battery-operated. In addition, the sensor is connected to a data line in order to transmit its measurement results to an evaluation device. As an alternative to the data line, a wireless radio link, for example Bluetooth, can also be installed for data transmission purposes. For laying both the electrical supply line and the data line, the push rod is preferably designed as a hollow profile for routing the said lines to the sensor. At the end of the push rod facing away from the sensor, the lines for the electrical supply and/or for the data transmission are routed in a cable duct in the base body provided specifically for that purpose.

At the end of the cable duct facing away from the push rod, the electrical connecting lines are connected to the rechargeable batteries of the industrial truck and the data line is connected to an existing evaluation device for evaluating the data with regard to any irregularities in the cubature of the shaded side of the load.

To allow for necessary buffering of the line lengths, a cable drag chain can be provided between the cable duct in the base body and the push rod for taking up line lengths when the push rod is retracted with the sensor into the load handling device or the base body thereof, and for providing the lines with sufficient length when the push rod is extended with the sensor into the surrounding area.

The entire movement apparatus with its subsystems—sensor-positioning means and drivetrain—is preferably integrated in a movement apparatus-receiving space in the base body. When the base body is a fork, the movement apparatus-receiving space is typically open at the bottom of the fork and thus freely accessible, but can be covered with the aid of a cover in order to protect the receiving space from dirt and the effects of weathering.

The above-mentioned object of the disclosure is furthermore solved by an industrial truck and by a method for operating the industrial truck. Advantageous designs of these solutions include, for example that the digital image data generated by the extended sensor for the shaded side of the load are preferably classified as to whether they lie within a predefined margin of error or not. When the margin of error is complied with, the observed shaded side of the load can be considered to be homogeneous and a volume measurement of the load based on this assumption can be considered valid for commercial and legal contexts. On the other hand, if it transpires when using the method to classify the digital image data or the measurement data that the cubature of the shaded side of the load is inhomogeneous, a volume determination of the load based on a homogeneous cubature can merely be regarded as an estimate, which, however, is not accurate enough for use, and is therefore unusable, in legal and commercial contexts.

Further advantageous embodiments of the load handling device, the industrial truck and the method for operating the industrial truck include, for example, a device for recording the length of the extension travel of the sensor from the base body, recording a desired angle of rotation α of the sensor about the longitudinal axis of the push rod, and weighing equipment integrated in the base body for recording the weight of the load.

### BRIEF DESCRIPTION OF THE DRAWINGS

FIG. 1 shows an industrial truck;

FIG. 2 shows a load handling device;

FIG. 3 shows a detail view of the guiding of the push rod;

FIG. 4 shows a detail view of the drivetrain;

FIG. 5 shows a side view of the load handling device;

FIG. 6 shows an industrial truck according to the prior art with picked-up load of homogeneous cubature on its rear side; and

FIG. 7 shows an industrial truck from the prior art having irregular cubature on its rear side.

### DETAILED DESCRIPTION

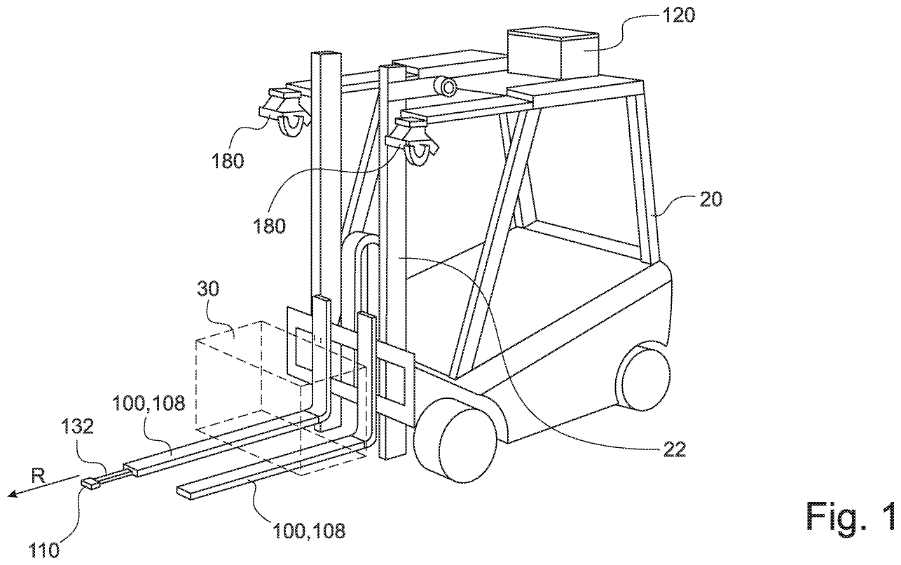

The invention is described in more detail hereinafter with reference to the mentioned FIGS. 1 to 5 in the form of exemplary embodiments. Identical technical elements are designated with identical reference signs throughout all of the exemplary embodiments.

FIG. 1 shows an industrial truck 20 having an attachment 22 and two forks mounted thereon. At least one of the two forks is designed in the form of a load handling device 100 having a base body 108. On this load handling device, a sensor 110 is extended with the aid of a push rod 132 in a direction of extension R. The sensor 110 is oriented with its viewing direction counter to the direction of extension R and here for example also counter to the direction of travel of the industrial trucks 20. Its viewing direction is in particular oriented towards the shaded side, facing away from the industrial truck, of any picked-up load 30.

Furthermore, a further digital sensor 180 is disposed on the industrial truck 20, here for example on the mast of the attachment for the forks. This further sensor is oriented with its viewing direction in the direction of travel of the industrial truck and towards any picked-up load in order to generate images of the sides of the load 30 that are visible from the industrial truck 20 or from this further sensor 180. An evaluation device 120 is not only designed for evaluating the digital image data for the extendable sensor 110, but also for evaluating the digital image data for the further sensor 180, in each case with regard to geometric measurement data for the sides of the load that are visible to the respective sensors 110, 180.

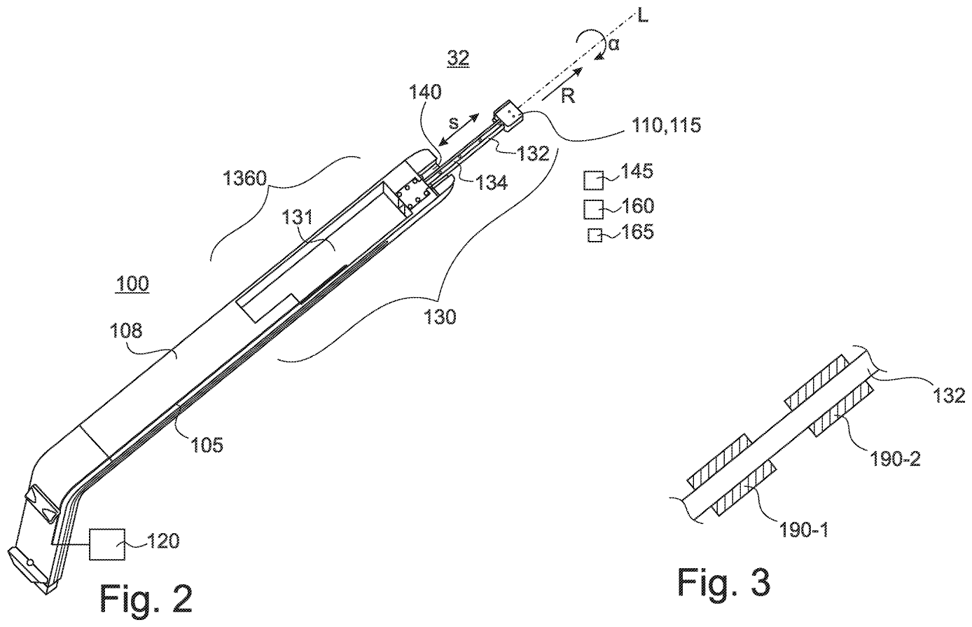

FIG. 2 shows a view of the underside of the load handling device 100 for picking up a load (not shown here). It can be seen that the load handling device 100 has the base body 108 in the form of a fork or a grapple. The digital sensor 110 which is installed in a protective housing 115 and is extended with the aid of the optional telescopic push rod 132 from a sensor-receiving space 140 at the front free end of the base body 180 can also be seen. The extending is effected in the direction of extension R by a travel distance s with the aid of a drivetrain 1360 of a movement apparatus 130, wherein the said push rod 132 is part of this movement apparatus 130.

As is apparent in FIG. 2, the sensor 110 is extended into the surrounding area of the load handling device 100, in particular—looking from the industrial truck 20—into the space 32 in front of the load handling device 100. The movement apparatus 130 is furthermore designed to return the digital sensor 110 into its sensor-receiving space 140.

The digital sensor 110 is designed in particular to identify the cubature, i.e. the shape or design and structure of the shaded side of the load 30 towards which it is oriented; see FIG. 1. For this purpose, the sensor 110 can be designed, for example, in the form of a radar sensor, a digital 2D or 3D camera and/or in the form of a laser scanner, for example a Light-Imaging, Detection and Ranging LIDAR sensor. Preferably, it is designed to record depth information about the shaded side under consideration.

With its end that faces away from the sensor 110, the push rod 132 is displaceably mounted in or on the base body 108 in at least one, preferably however at least two push rod bearings 190; see FIG. 3. Preferably, at least two short push rod bearings 190-1, 190-2 are disposed one behind the other in the longitudinal direction L of the push rod. This has the advantage that any bending of the base body owing to a heavy load does not lead to the push rod getting jammed in the push rod bearings; rather, the extending and retraction of the push rod with the sensor continues to function properly. The push rod bearings 190-1, 190-2 are preferably in the form of linear ball bearings.

In addition to the push rod 132 and the push rod bearings 190-1, 190-2 thereof, the movement apparatus 130 also comprises a drivetrain 1360, which brings about the extension and retraction of the push rod 132 with the sensor 110.

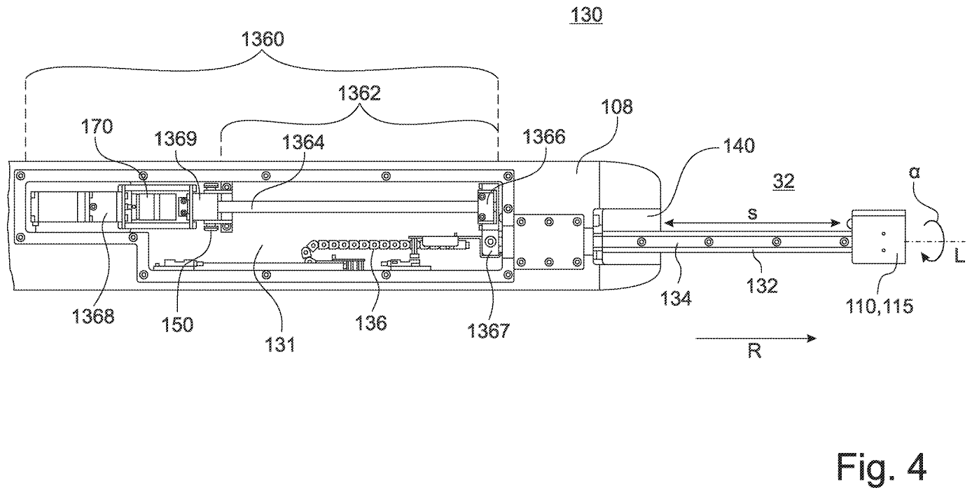

According to FIG. 4, the drivetrain 1360 has a leadscrew 1362 with a spindle 1364 and a spindle nut 1366 which is screwed onto the spindle and to which the push rod 132 is flange-connected with the aid of a connecting element 1367. The leadscrew 1362 is assigned a gear motor 1368 for linearly moving the spindle nut 1366 along the spindle together with the flange-connected push rod 132 and the sensor 110 by driving the spindle in rotation. In this sense, the leadscrew 1362 ultimately brings about the transformation of the rotary motion of the gear motor 1368 into a translational motion of the spindle nut and therefore—owing to the said coupling via the connecting element 1367—brings about the said extension and retraction of the sensor 110.

As is also apparent in FIG. 4, the gear motor 1368 and the leadscrew 1362 are coupled to each other for rotation via an interposed friction clutch 170. The thus configured drivetrain 1360 is preferably connected to the base body 108 via a combined axial and/or radial bearing 1369, which for its part is mounted in a pivot bearing 150. The tilt axis or pivot axis A of the pivot bearing 150 is oriented perpendicular to the longitudinal axis and parallel to a virtual bending axis of the base body, about which the base body bends when it is subjected to loading. As described in the introduction, this particularly configured mounting of the drivetrain as a single entity ensures that it remains fully functional even if the base body 108 bends when picking up a heavy load.

The gear motor 1368 can be designed as an electromagnetic, pneumatic or hydraulic drive.

A distance measurement device 160 can be installed in the base body 108 of the load handling device 100 for recording the magnitude of the travel distance s by which the sensor 110 has been extended out of the base body 108 each time.

The push rod 132 can be mounted on the base body 108 in such a way that it can or cannot twist. The twistability enables different viewing directions of the sensor 110 at different angles of twist α. Therefore, different images of the shaded side of the load can be also generated at a different extension travel s and/or different angle of twist of the sensor.

An anti-twist lock of the push rod 132 can be realised, for example, by designing the cross-section of the push rod to be angular rather than round. This can be realised, for example, by placing a guide strip on a tubular base body of the push rod, or by designing the push rod in the form of a hollow profile with a non-round cross-section, i.e. for example with a polygonal cross-section or with at least one bent edge.

The push rod bearings 190-1, 190-2 should then be designed to be complementary to the cross-section of the push rod, so that the push rod can be mounted and guided in the bearings such that it cannot twist.

If, by contrast, the push rod 132 is meant to be able to twist with the sensor 132, a rotation device 145 should be provided for rotating the extendable push rod and/or the extendable sensor 110 through an angle of rotation α, for example about the longitudinal axis L of the push rod 132, into a desired viewing direction.

As is apparent in FIGS. 2 to 4, the entire movement apparatus 130, i.e. the push rod 132 with its push rod bearings 190-1, 190-2 and the entire drivetrain 1360 is integrated in a movement apparatus-receiving space 131 in the base body 108. This receiving space and thus the said movement apparatus are preferably accessible at the underside of the base body 108, as shown in FIG. 2. However, the receiving space 131 can preferably be covered with the aid of a cover (not shown in FIG. 2) and in this way protected from dirt and environmental influences.

Furthermore, weighing equipment 165 can be arranged in or on the base body 108, independent of the movement apparatus 130, for determining the weight of the load 30 picked up by the load handling device.

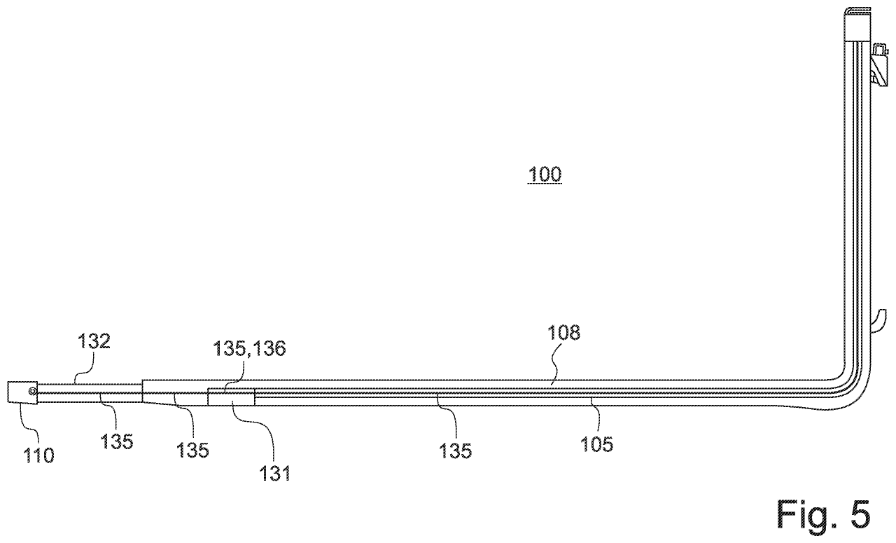

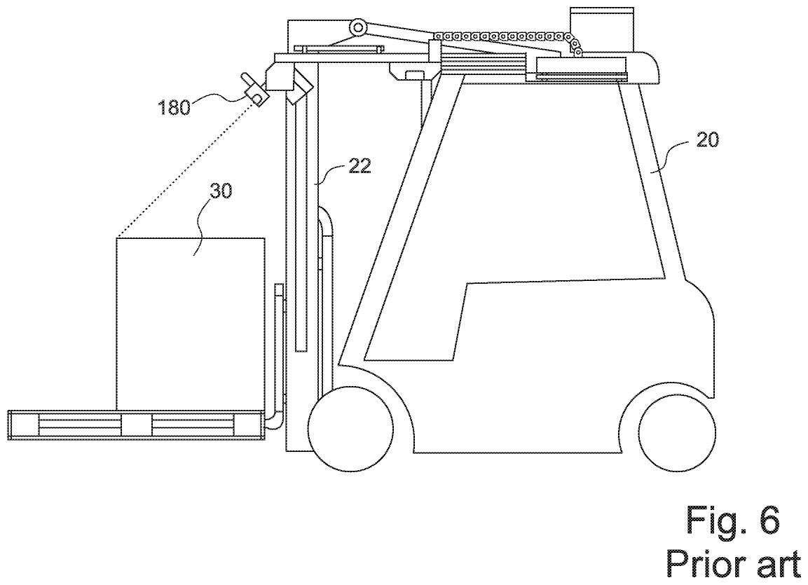

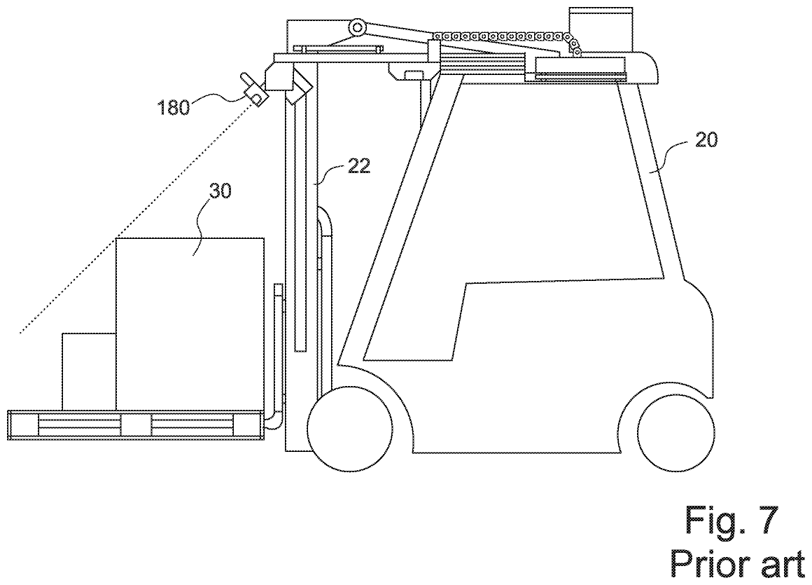

Lastly, FIG. 5 shows a cable duct 105 in the base body 108 for routing electrical supply and/or data lines 135 from the receiving space 131 to the industrial truck, so as to be connected there to the power supply, typically a rechargeable battery, and to the image data-evaluation device 120.

Optionally, as is apparent in FIG. 4, a cable drag chain 136 can be disposed in the receiving space 131 between the end of the cable duct 105 and the push rod 132, preferably designed as a hollow shaft profile, for buffering or temporarily storing cable lengths of the electrical supply and/or data lines 135. Specifically, this cable drag chain 136 is designed to temporarily store partial lengths of the said lines when the push rod 132 with the sensor 110 is retracted into the load handling device 100 or the base body 108 thereof, and for providing the lines 135 with sufficient length when the push rod 132 with the sensor 110 is extended into the surrounding area of the load handling device 100.

The operation of the industrial truck 20 is described hereinafter:

This method has in particular the following steps:
picking up a load 30 using the load handling device 100;
extending the sensor 110 in a direction of extension R beyond the base body 108 of the load handling device 100 into the surrounding area of the load 30;
generating digital image data for at least one shaded side of the load 30 that becomes visible when a viewing direction of the extendable sensor 110 is rearward-facing in relation to the direction of extension R; and
evaluating the digital image data with regard to geometric measurement data for the shaded side of the load 30 under consideration.

The recorded geometric measurement data are assessed or classified as to whether they represent—within predefined margins of error—a homogeneous or an inhomogeneous side of the load 30.

The volume of the load 30 is traditionally ascertained on the basis of the image data generated by the further sensor 180 on the industrial truck 20 and the geometric measurement data derived therefrom. In this case, these image and measurement data relate to the sides of the load 30 that are visible to the further sensor 180. For the shaded side of the load 30 that is not visible to the further sensor 180, the traditional volume calculation presupposes that this side is homogeneous or as to be expected. This means, for example, that in the case of a load that looks cuboidal when viewed from the control platform of the industrial truck 20, it is presumed that the shaded or rear side thereof is planar and that no bulges or further loads are present there. However, if it is established in this case with the aid of the method and the extendable sensor 110 that the shaded side of the load 30 is not homogeneous, the result of the previous volume calculation is classified as an estimate that cannot be used in a legal and/or commercial context.

The method can also provide for ascertaining the weight of the load 30 picked up by the load handling device 100, preferably by the weighing equipment 165 integrated in the base body 108. Furthermore, when the sensor is extended from the base body 108, the extension travel s and/or the angle of rotation α of the extendable sensor 110 can be recorded so that they can also be taken into account when ascertaining the geometric measurement data, in particular for the shaded or rear side of the load. This improves the evaluation of this data with regard to the homogeneity or inhomogeneity of the shaded side of the load.

A further improvement when calculating the volume of the load can be achieved by the shaded side of the load being viewed not only from one viewing position, but from different or multiple viewing positions, and different image data can be recorded and generated in each of the different viewing positions. These different viewing positions and viewing directions can arise due to different angles of rotation of the extendable sensor 110 and/or different travel distances s by which the extendable sensor 110 was extended.

### LIST OF REFERENCE NUMERALS

20 industrial truck
22 attachment
30 load
32 space in front of the load handling device
100 load handling device
105 cable duct
108 base body
110 sensor, extendable
115 protective housing
120 evaluation device
130 movement apparatus
131 movement apparatus-receiving space
132 push rod
134 anti-twist lock
135 supply and/or data lines
136 cable drag chain
140 sensor-receiving space
145 rotation device
150 pivot bearing
160 distance measurement device
165 weighing equipment
170 friction clutch
180 further digital sensor
190-1, 190-2 push rod bearings
1360 drivetrain
1362 leadscrew
1364 spindle
1366 spindle nut
1367 connecting element
1368 gear motor
1369 axial and/or radial bearing
α angle of rotation
A pivot axis
L longitudinal axis of the push rod
R direction of extension
s extension route

What is claimed is:

1. A load handling device (100) for an industrial truck (20), the load handling device (100) being configured to pick up a load, the load handling device (100) comprising:
a base body (108) configured as a fork or a grapple;
a sensor (110) configured to generate digital image data;
an evaluation device (120) configured to evaluate the digital image data; and
a movement apparatus (130) configured to extend the sensor (110) in an extension direction (R) into a surrounding area of the load handling device (100) and to retract the sensor (110),
wherein the sensor (110) is oriented in a rearward-facing viewing direction relative to the extension direction (R) to generate the digital image data corresponding to at least portions of a shaded side of the load.

2. The load handling device (100) according to claim 1,
wherein the movement apparatus (130) configured to extend the sensor (110) into a space (32) in front of the load handling device (100) relative to the industrial truck (20),
wherein the sensor (110) comprises one or more of a radar sensor, a digital 2D camera, a digital 3D camera, or a laser scanner, and
wherein the sensor (110) is configured to record depth information.

3. The load handling device (100) according to claim 1,
wherein the base body (108) comprises a sensor-receiving space (140) at, or adjacent to, a front free end of the base body (108), the sensor-receiving space (140) being configured to receive the sensor (110), and
wherein the sensor (110) is movable out of and into the sensor-receiving space (140) via the movement apparatus (130).

4. The load handling device (100) according to claim 1,
further comprising a protective housing (115),
wherein the sensor (110) is disposed within the protective housing (115).

5. The load handling device (100) according to claim 1,
wherein the movement apparatus (130) comprises:
a push rod (132) having a first end and a second end, the first end being displaceably mounted in or on the base body (108), and the sensor (110) being coupled to the second end; and
a drivetrain (1360) configured to linearly move the push rod (132) to extend the sensor (110) into the surrounding area of the load handling device (100) and to retract the sensor (110).

6. The load handling device (100) according to claim 5,
wherein the drivetrain (1360) comprises
a leadscrew (1362) including a spindle (1364) and a spindle nut (1366) threaded onto the spindle, the push rod (132) is flange-connected to the spindle nut (1366) via a connecting element (1367); and
a gear motor (1368) configured to rotate the spindle (1364) to thereby linearly move the spindle nut (1366) along the spindle together, together with the push rod (132) and the sensor (110).

7. The load handling device (100) according to claim 6,
wherein the drivetrain (1360) is a contiguous unit,
wherein the drivetrain is coupled to the base body (108) via a single pivot bearing (150),
wherein the single pivot bearing (150) is configured with axial play to permit a tilting movement of the drivetrain (1360) about a pivot axis (A) of the single pivot bearing in response to bending of the base body due to the load (30); and
wherein the drivetrain (1360) is mounted on the single pivot bearing (150) via an axial and/or radial bearing (1369).

8. The load handling device (100) according to claim 1,
further comprising a distance measurement device (160) configured to determine a position of the sensor (110) relative to the base body (108).

9. The load handling device (100) according to claim 7,
further comprising a friction clutch (170) coupled between the gear motor (1368) and the leadscrew (1362),
wherein the friction clutch (170) is disposed, preferably, between the gear motor (1368) and the axial and/or radial bearing (1369).

10. The load handling device (100) according to claim 6,
wherein the gear motor (1368) is an electromagnetic, pneumatic or hydraulic drive.

11. The load handling device (100) according to claim 5,
further comprising two push rod bearings (190-1, 190-2) fixed in or to the base body (108),
wherein the two push rod bearings (190-1, 190-2) comprise linear ball bearings arranged offset from one another in a longitudinal direction of the push rod (132) to support displacement of the push rod (132).

12. The load handling device (100) according to claim 11,
wherein the push rod (132) comprises an anti-twist lock (134) configured as a guide strip or a bent edge; and
wherein the push rod bearings (190-1, 190-2) are configured to mount and guide the push rod (132) such that the anti-twist lock (134) prevents rotation of the push rod (132).

13. The load handling device (100) according to claim 5,
further comprising a rotation device (145) configured to rotate the sensor (110) by an angle of rotation (α) about a longitudinal axis (L) of the push rod (132) in a desired viewing direction.

14. The load handling device (100) according to claim 6,
wherein the base body (108) comprises a cable duct (105);
wherein the push rod (132) comprises a hollow shaft profile;
wherein the cable duct (105) and the hollow shaft profile are configured to route electrical supply and/or data lines from the industrial truck (20) to the sensor (110); and
wherein a cable drag chain (136) is disposed between an end of the cable duct (105) and the hollow shaft profile of the push rod (132), the cable drag chain (136) being configured to accommodate a portion of the electrical supply and/or data lines when the push rod (132) is retracted and to provide sufficient line length when the push rod (132) is extended.

15. The load handling device (100) according to claim 1,
wherein the base body (108) defines a movement apparatus-receiving space (131) in which the movement apparatus (130) is disposed; and
wherein the movement apparatus-receiving space (131) is open at a top side or a bottom side of the base body (108), and is optionally covered by a cover.

16. The load handling device (100) according to claim 1,
further comprising weighing equipment (165) configured to determine a weight of the load.

17. An industrial truck (20), comprising:
an attachment (22); and
at least one load handling device (100) according to claim 1 mounted on the attachment (22),
wherein a rearward-facing viewing direction of the sensor (110), relative to the extension direction (R), corresponds to a viewing direction toward shaded sides of the load (30) that face away from the industrial truck (20).

18. The industrial truck (20) according to claim 17,
further comprising a further sensor (180) mounted on a control platform of the industrial truck (20), on the attachment (22), or on a rear side of the load handling device (100), the further sensor (180) being configured to generate further digital image data in a viewing direction oriented in a direction of travel of the industrial truck (20) toward the load (30),
wherein the evaluation device (120) is configured to evaluate the further digital image data generated by the further sensor (180) to obtain geometric measurement data corresponding to sides of the load (30) that are visible from the industrial truck (20).

19. A method, comprising:
providing the industrial truck (20) of claim 18;
picking up the load (30) using the load handling device (100);
extending the sensor (110) in the direction of extension (R) beyond the base body (108) of the load handling device (100) into the surrounding area of the load (30);
generating digital image data for at least one shaded side of the load (30) that becomes visible when the viewing direction of the sensor (110) is rearward-facing in relation to the direction of extension; and
evaluating the digital image data with regard to geometric measurement data for the shaded side of the load (30) under consideration.

20. The method according to claim 19, further comprising
assessing and classifying the geometric measurement data as to whether they represent, within predefined margins of error, an inhomogeneous or a homogeneous side of the load (30); and/or
ascertaining a volume of the load (30) based on the further digital image data generated by the further sensor (180) and the geometric measurement data derived therefrom for sides of the load (30) that are visible to the further sensor (180), based on an assumption that a rear side of the load that is not visible is homogeneous,
wherein when the rear side of the load is classified as being inhomogeneous, the volume of the load is classified as an estimate that cannot be used in a legal and/or commercial context, and/or
ascertaining a weight of the load (30) picked up by the load handling device (100) by weighing equipment (165) integrated in the base body (108) of the load handling device, and/or
recording an extension travel(s) and/or an angle of rotation (α) of the sensor (110) when extended from the base body (108) of the load handling device (100), and taking the extension travel(s) and/or the angle of rotation (α) of the sensor (110) into account when ascertaining the geometric measurement data for the rear side of the load, and/or
generating the digital image data when the sensor (110) stops at different positions along an extension route and/or is rotated through different angles of rotation (α).
